(19) United States
(12) Patent Application Publication
(10) Pub. No.: US 2024/0337345 A1
(43) Pub. Date: Oct. 10, 2024

(54) PROTECTOR FOR A THREADED END OF A TUBULAR COMPONENT

(71) Applicant: VALLOUREC OIL AND GAS FRANCE, Aulnoye-Aymeries (FR)

(72) Inventors: Yann GALLOIS, Meudon (FR); Didier DAVID, Meudon (FR)

(73) Assignee: VALLOUREC OIL AND GAS FRANCE, Aulnoye-Aymeries (FR)

(21) Appl. No.: 18/688,957

(22) PCT Filed: Sep. 27, 2022
(86) PCT No.: PCT/FR2022/051813

§ 371 Date: Mar. 4, 2024

(30) Foreign Application Priority Data
Sep. 28, 2021 (FR) 2110233

(51) Int. Cl. F16L 57/00

(52) U.S. Cl. CPC F16L 57/005

(57) ABSTRACT

A protector for protecting a male or female threaded end of a tubular component for drilling, for the exploitation of hydrocarbon wells, for transporting oil and gas, for transporting or storing hydrogen, for capturing carbon or geothermal energy, the male or female threaded end being provided with at least one external or internal thread, the protector includes a main body that is intended to receive the male or female threaded end, the main body having a peripheral side wall extending in an axial direction, wherein a housing is provided in a thickness of the peripheral side wall, said housing extending around the peripheral side wall, at least one threaded ring detachably housed in said housing, the threaded ring having a thread that is intended to be screwed onto the external or internal thread of the male or female threaded end.

### TECHNICAL FIELD

The invention relates to threaded tubular components and more specifically to protectors for protecting the end of these components, in particular oil or gas well drilling or exploitation pipes.

“Tubular component” is understood herein to mean any element or accessory used to drill or exploit a well and comprising at least one threaded end, also called connection or connector, and intended to be assembled by a thread to another tubular component in order to form a tubular threaded joint with this other component. The tubular component can be, for example, a relatively long tubular element (in particular approximately ten metres long), for example, a pipe, or even a tubular sleeve a few tens of centimetres long, or even an accessory for these tubular elements (a hanger device, a cross-over part, a safety valve, a tool joint connector, a sub, and the like).

Tubular components are generally assembled together in order to be lowered into hydrocarbon wells or similar wells and to form a drilling lining, a column of casing or liner pipes or even a column of production pipes (“tubing”) (exploitation columns).

American Petroleum Institute (API) specification API 5CT, which is equivalent to International Standardisation Organisation (ISO) standard ISO 11960, governs pipes used as casing or tubing, and API specification 5B defines standard threads for these pipes.

API Specification 7 defines shoulder threaded connections for rotary drilling rods.

Threaded connections usually comprise one or more thread(s) with substantially trapezoidal threads and comprise a stabbing flank on the side of the threads facing the free end of the considered threaded element, a loading flank on the opposite side of the stabbing threads, a thread crest of non-zero width and a thread root also of non-zero width, with the loading flanks and the stabbing flanks being oriented substantially perpendicular to the axis of the threaded element (for example, the API Buttress thread has, according to the API standard, an incline of +3° for the loading flanks, and an incline of +10° for the stabbing flanks).

Triangular or round threads also exist with stabbing flanks and loading flanks, the crests and roots of which have a substantially zero width, but which are currently very rarely used since they exhibit a high risk of disengagement (“jump-out”).

The aforementioned tubular components can comprise a threaded male end that is intended to be screwed into a threaded female end of another tubular drilling or exploitation component. It is therefore essential that their male and female ends are damaged, contaminated and deteriorated as little as possible between the time they leave their manufacturing line and the time they are used, but also between two successive uses. It will be understood that it is indeed necessary for not only the thread, but also any bearing surface(s) and stop(s) to be protected against corrosion, dust and shocks (or impacts), with each having specific and complementary functions, particularly with a view to providing a seal during the operating phase.

Furthermore, the ends of the aforementioned components were generally coated with a grease with anti-seizing properties immediately before assembly.

It is increasingly common to replace this grease with a combination of surface treatments and coatings applied to the connections in thin layers, i.e., to the thread, the bearing surface and/or the stop.

Protectors are devices designed to protect the functional surfaces of male or female connections. These functional surfaces can be one or more thread(s), one or more bearing surface(s), one or more stop(s). A protector assumes a general substantially cylindrical shape and generally comprises a body, a securing means and optionally a mechanical shock absorber, called bumper, located at the end opposite the free end of the protector. The solution that is generally suitable for securing a protector to a connection is to screw it onto the thread of the connection. This solution allows a simple mounting procedure to be provided, combined with precise positioning. The protector therefore comprises a thread that can be screwed onto the thread of the connection. The thread is usually of the same type and pitch as that of the connection. A protector thread therefore comprises threads with stabbing flanks on the side of the threads facing the free end of the protector and intended to come into contact with stabbing flanks of the threads of a connection when the protector is screwed onto the connection, loading flanks, thread crests and roots and at least one stop.

The main purpose of a protector is to protect the connection of a tubular component (intended for drilling or exploitation of hydrocarbon wells or the like) against various types of external aggression: mechanical damage such as mechanical shocks, contamination (chemical and equipment) such as dust deposited on the functional surfaces, and corrosion of equipment between the time the tubular component leaves its manufacturing line and the time it is used (with several assembly/disassembly operations being possible for the protection device).

However, the applicant has realized that when transporting or handling pipes on which the known protectors are mounted, the functional surfaces of the connections are insufficiently protected against damage, in particular from mechanical shocks. Furthermore, known protectors can become partially or completely unscrewed or the functional surfaces even can be damaged despite the presence of the known protector mounted on the connection.

Thus, a genuine requirement exists for developing a protector for addressing the aforementioned problems.

### SUMMARY

One idea behind the invention is a protector for protecting a threaded end, in particular when transporting and storing said threaded end.

Another idea behind the invention is a protector, which, once mounted on a threaded end, does not unscrew unintentionally.

Another idea behind the invention is a reusable and adaptable protector, i.e., one that can be modified in order to adapt to various types of connections.

Another idea behind the invention is a protector that facilitates cleaning grease from the bottom of the protector, in particular from the smooth parts of the protector.

Another idea behind the invention is to produce a reliable and economical protector due to the possibility of only replacing the thread of the protector instead of the whole protector.

According to one embodiment, the invention provides a protector for protecting a male or female threaded end of a tubular component for drilling, for the exploitation of hydrocarbon wells, for transporting oil and gas, for transporting or storing hydrogen, for capturing carbon or geothermal energy, the male or female threaded end being provided with at least one external or internal thread, the protector comprising:
a main body that is intended to receive the male or female threaded end, the main body comprising a peripheral side wall extending in an axial direction, wherein a housing is provided in a thickness of the peripheral side wall, said housing extending around the peripheral side wall;
at least one threaded ring detachably housed in said housing, the threaded ring having a thread that is intended to be screwed onto the external or internal thread of the male or female threaded end.

By virtue of these features, the protector can be introduced on a male or female threaded end for the protection thereof. Furthermore, part of the protector is reusable. Indeed, the threaded ring initially housed in the protector housing can be replaced by another threaded ring, which affords the protector adaptability, allowing it to be reused for the same male or female threaded end or a threaded end comprising a different thread.

By virtue of these features, the threaded ring and the housing help to create a thread interference and thus add more torque value to the protector.

A protector according to the invention allows quick and reliable on-site assembly and disassembly of the protector on a tubular component connection and allows easy inspection of the condition of the threads before use or between two successive uses of the component.

A protector according to the invention prevents premature or unwanted unscrewing of the protector. Indeed, an axial force associated with a rotation must be provided to allow the protector to be initially mounted on a tubular element. When the protector is in the screwed position, the ring is in the screwed position on the tubular threaded element. The main body can be caused to move around the threaded tubular element without the protector disengaging from the connection to be protected. Only the application of a reverse rotation and optionally of an axial force will allow the protector to be removed. A transfer of force between the threaded ring and the body of the protector can occur in various ways, for example, by friction or by gearing. Frictional contact can occur on one or two axial surface(s) of the housing against one or two axial surface(s) of the ring. Such friction or geared contact allows the ring to be unscrewed from the connection when the main body of the protector is unscrewed.

A tubular component for drilling and exploiting oil or gas wells is generally made up of a body and of two connections on either side of the body for connecting the tubular component to other tubular components. The component can be made of steel, stainless steel, and/or aluminium.

In particular, a pipe comprises a body and a connection or threaded end at each end, on either side of the body. A connection can be an end portion of the body provided with machined surfaces with a view to forming a joint with a corresponding connection of another tubular body. Alternatively, a connection can be a machined portion of a sleeve applied by welding or screwing onto a tubular component body. Again alternatively, a connection can be a sleeve welded onto a tubular component body.

A “male connection” or “male threaded end” is understood to mean the portion of a component provided with machined and/or ground surfaces with a view to forming a joint with a corresponding female connection. A male connection generally has one or more thread(s) located on an external side wall of the end of the component and a corresponding female connection has one or more corresponding thread(s) on an internal side wall of the end of the component.

A component can be provided with two male connections, one male connection and one female connection, or two female connections.

According to the embodiments, such a protector can comprise one or more of the following features.

According to one embodiment, the main body has a bottom wall that is located at an axial end of the peripheral side wall, with the peripheral side wall completely extending around the bottom wall.

According to one embodiment, the bottom wall has a through opening.

According to one embodiment, the threaded ring completely extends around the housing.

According to one embodiment, the threaded ring is discontinuous in order to be able to be deformed when inserted into the housing or removed from said housing.

According to one embodiment, the threaded ring has a weakened thickness area in order to increase the resilient deformability of said threaded ring.

By virtue of these features, the threaded ring is resiliently deformable, allowing it to be easily mounted on or removed from the housing of the main body.

According to one embodiment, the threaded ring has a right-hand thread, i.e., the tightening direction is from left-to-right.

According to one embodiment, the threaded ring has a left-hand thread, i.e., the tightening direction is from right-to-left.

According to one embodiment, a shape of the threaded ring is selected from among: a cylindrical, a stepped cylindrical, a helical and a frustoconical shape.

According to one embodiment, a shape of the housing is selected from among: a cylindrical, a stepped cylindrical, a helical and a frustoconical shape.

According to one embodiment, the shape of the threaded ring and the shape of the housing are matching shapes.

According to one embodiment, a shape of the threaded ring and a corresponding shape of the housing are selected from among: a cylindrical shape, a stepped cylindrical shape, a helical shape and a frustoconical shape.

According to one embodiment, the threaded ring comprises a non-threaded surface that conforms to the housing in order to increase the contact surface area between the threaded ring and the housing. For example, the threaded ring comprises bends and/or stops in order to adapt to the housing.

According to one embodiment, the housing has at least one flange intended to stop the threaded ring in the axial direction.

Thus, once the threaded ring is housed in the housing, the threaded ring will not unintentionally dislodge, the threaded ring is held in the housing.

According to one embodiment, the flange has a notch intended to facilitate the removal of the threaded ring from the main body.

By virtue of these features, the threaded ring is easily dislodged and removed from the housing of the main body, for example, via a flat metal tab or a flat-head screwdriver.

According to one embodiment, the housing has a second flange intended to stop the threaded ring in the axial direction.

According to one embodiment, the housing is provided in a thickness of the peripheral side wall.

According to one embodiment, the depth of the housing ranges between 0.2 mm and 20 mm.

According to one embodiment, the length of the housing ranges between 2 mm and 300 mm.

According to one embodiment, the diameter of the threaded ring ranges between 50 mm and 700 mm.

According to one embodiment, the housing is provided throughout the thickness of the peripheral side wall, i.e., the housing completely passes through following the direction of the thickness of the peripheral wall.

According to one embodiment, the housing extends over a portion of the circumference of the peripheral side wall. According to one embodiment, the housing extends at least over ¾ of the circumference of the peripheral side wall.

According to one embodiment, the housing extends over the entire circumference of the peripheral side wall.

According to one embodiment, a blocking means blocks a rotational movement of the threaded ring relative to the main body in order to be able to screw or unscrew the threaded ring by exerting a rotational torque on the main body.

According to one embodiment, the blocking means comprises a rib-groove system for rotationally securing an external or internal surface of the threaded ring to an internal or external surface of the peripheral side wall.

According to one embodiment, the discontinuous threaded ring comprises a discontinuous area, said discontinuous area forming said groove, and wherein the discontinuous area engages with a rib formed on the internal or external surface of the peripheral side wall.

By virtue of these features, the discontinuous threaded ring is deformable and can be easily mounted on or removed from the housing of the main body. Furthermore, the rib-groove system allows the threaded ring to be easily screwed or unscrewed.

According to one embodiment, the discontinuous area is stair-shaped.

According to one embodiment, the rib-groove system comprises a groove formed in a non-threaded surface of the threaded ring and a rib located in the housing and intended to be housed in said groove.

Thus, the threaded ring can extend into the housing and over the entire circumference of the peripheral side wall.

According to one embodiment, the blocking means is selected from among:
a frustoconical portion formed by a non-threaded surface of the threaded ring and/or by an internal or external surface of the peripheral side wall, the frustoconical portion allowing the non-threaded surface of the threaded ring to be frictionally secured to the internal surface or to the external surface of the peripheral side wall in response to an axial thrust force exerted on the threaded ring towards the bottom wall;
a thickness of the threaded ring that is greater than a depth of the housing in order to frictionally secure the non-threaded surface of the threaded ring to the internal or external surface of the peripheral side wall by screwing the external or internal thread of the male or female threaded end of the tubular component to the threaded ring, with the male or female threaded end of the tubular component being adapted to cause radial expansion of the threaded ring in response to said screwing.

According to one embodiment, the main body exhibits a certain level of stiffness while being capable of at least partially absorbing shocks.

According to one embodiment, the main body or the ring are made of a polymer material, for example, by injecting a thermoplastic material into a suitable mould.

According to one embodiment, the main body or the ring are made of a thermoplastic material selected from among: polycarbonate-based blends such as polycarbonate-polyester (PC-PBT or PC-PET) and high (PE-HD) or ultra-high density (PE-UHD) polyethylenes (PE).

According to another embodiment, the main body or the ring is made by additive manufacturing from a material selected from among: polyamides, elastomers, filled polymers, metal materials or a combination thereof.

In cases where compliance with the API 5CT specification is desired, appendix I of which makes provision for requirements for thread protection devices, in particular minimum values for axial impact resistance and bias (at 45° for three temperatures (−46, +21 and +66° C.), for example, a PE-HD product by DOW and sold under the name DMBA-8904-NT7 or produced by BASELL and sold under the name LUPOLEN 4261 AG UV 6005, a PE-UHD product by TICONA and sold under the name GUR 5113, or a PC-PBT product by BAYER and sold under the name MAKROBLEND S7916 can be more specifically selected.

According to one embodiment, the main body is partially honeycombed, particularly in the thick portions thereof, in order to better absorb any impacts.

According to one embodiment, the protector comprises a plurality of housings arranged stepwise in the axial direction of the main body and a plurality of threaded rings respectively detachably arranged in said housings.

According to one embodiment, threads of the plurality of threaded rings are different from each other.

According to one embodiment, a lower seal is located on the bottom wall and is intended to establish a sealed contact with the male or female threaded end of the tubular component.

Thus, a sealing area is formed at the contact area with the male or female threaded end.

According to one embodiment, the lower seal is detachably attached to the main body.

Thus, the lower seal can be easily replaced without changing the entire protector.

According to one embodiment, the lower seal assumes the shape of a truncated cone diverging towards the bottom wall.

By virtue of these features, the seal formed at the contact area with the male or female threaded end is enhanced.

According to one embodiment, the peripheral side wall has an axial end remote from the bottom wall, with an upper seal being located on the axial end and being intended to establish a sealed contact with the male or female threaded end of the tubular component.

According to one embodiment, the upper seal is detachably attached to the main body.

Thus, the upper seal can be easily replaced without changing the entire protector.

According to one embodiment, the protector further comprises a data medium for memorizing, storing, or recording data, using “Radio Frequency Identification” (RFID) technology.

The data medium comprises, for example, information concerning: the protector, the tubular component, the match between the protector and the male or female threaded end of the tubular component, the goods being transported and/or the goods carrier.

According to one embodiment, the data medium is located in the main body, the housing, the threaded ring, the lower seal or the upper seal.

According to one embodiment, a protector according to the invention is a protector wherein the threaded ring (8, 108) and/or the main body (2, 102) is manufactured by additive manufacturing, by moulding or by machining from one or more materials.

According to one embodiment, manufacturing involves using the same material or several different materials.

According to one embodiment, the additive manufacturing that is used is carried out by deposition welding, by electron beam melting, by laser melting on a metal powder bed or “selective laser melting”, by multi-jet melting, by molten wire deposition, by Polyjet, by vacuum casting, by selective laser sintering, by stereolithography in a resin bath, by direct metal deposition or “Direct Energy Deposition”, by binder spray deposition or by laser spray deposition, or by arc-wire additive manufacturing. Each of these production methods allows impregnation with another material, which can be hydrophobic, lubricating, conducting, insulating, fluorescent, etc.

The invention also provides an assembly comprising a tubular component having a male or female threaded end and a protector as described above attached to the male or female threaded end by screwing.

### BRIEF DESCRIPTION OF THE FIGURES

The invention will be better understood, and further aims, details, features and advantages thereof will become more clearly apparent, throughout the following description of several particular embodiments of the invention, which are provided solely by way of a non-limiting illustration, with reference to the accompanying drawings.

FIG. 1 shows an exploded section view of a male threaded end of a tubular component and of a protector according to one embodiment.

FIG. 2 shows an exploded perspective view of a protector according to one embodiment.

FIG. 3 shows a perspective view of a threaded ring according to one embodiment.

FIG. 4 shows a perspective view of a main body capable of housing the threaded ring shown in FIG. 3.

FIG. 5 shows a perspective view of a protector according to one embodiment.

FIG. 6 shows a top view of the lower seal of the protector shown in FIG. 5.

FIG. 7 shows a perspective view of a discontinuous threaded ring according to one embodiment.

FIG. 8 shows a perspective view of a protector body suitable for receiving the threaded ring of FIG. 7, before the insertion of the threaded ring.

FIG. 9 is a similar view to FIG. 8 during the insertion of the threaded ring.

FIG. 10 is a view similar to FIGS. 8 and 9 after the insertion of the threaded ring into the housing.

FIG. 11 shows a section view of a protector comprising a frustoconical peripheral side wall.

FIG. 12 shows a section view of a protector comprising a threaded ring when screwing a tubular component.

FIG. 13 shows an exploded perspective view of a protector, in which the threaded ring and the housing have helical shapes.

FIG. 14 shows a perspective view of a threaded ring of the protector of FIG. 13.

FIG. 15 is a section view of a protector for a female threaded end of a tubular component according to one embodiment.

FIG. 16 shows a section view of the protector shown in FIG. 16 in the assembled state on a female threaded end of a tubular component.

FIG. 17 shows an exploded perspective view of the protector shown in FIGS. 16 and 17 and of the female threaded end of a tubular component.

### DESCRIPTION OF THE EMBODIMENTS

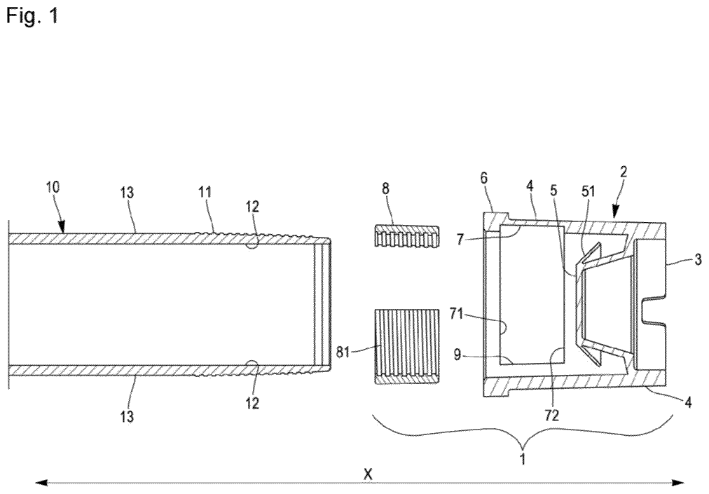

FIGS. 1 to 14 show protectors for protecting a tubular component having a male threaded end, i.e., having an external thread.

FIG. 1 shows a tubular component 10 and a protector 1 corresponding thereto. The tubular component 10 has a generally cylindrical shape and has a male threaded end 11, i.e., having an external thread.

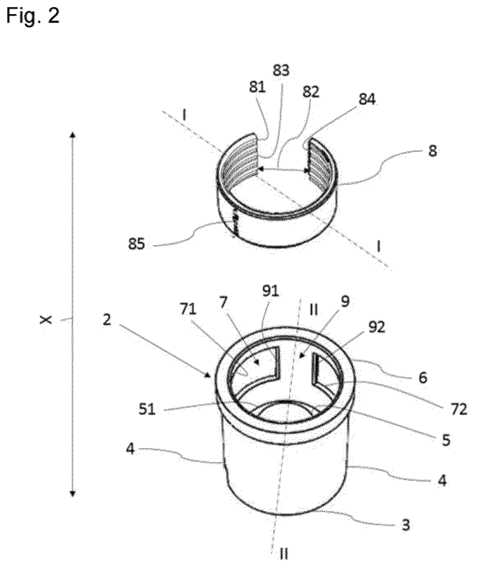

The protector 1 comprises a main body 2 intended to receive the male threaded end 11. The main body 2 in FIG. 1 is a section view along the axis II-II shown in FIG. 2. The main body 2 is hollow and comprises a bottom wall 3 and a peripheral side wall 4 extending from the bottom wall 3 in an axial direction X completely around the bottom wall 3.

A lower seal 5 integrally formed with the main body 2 is located on the bottom wall 3. The lower seal 5 comprises a circular area 51 that is intended to establish a sealed contact with an internal surface 12 of the male threaded end portion 11.

Furthermore, an upper seal 6 integrally formed with the main body is located at an upper end of the main body 2. The upper seal 6 completely extends around the upper end of the main body 2 and is intended to establish a sealed contact with an external surface 13 of the tubular component 10.

The main body 2 further comprises a housing 7 that is arranged in the thickness of the peripheral side wall 4 without passing through the peripheral side wall 4. The housing 7 is located between the lower seal 5 and the upper seal 6 and extends around the peripheral side wall 4 over an angular sector of approximately 320°. The housing 7 is intended to house a threaded ring 8. The housing 7 has an upper flange 71 intended to stop the threaded ring 8 in the axial direction X, towards the upper seal 6, and a lower flange 72 intended to stop the threaded ring 8 in the axial direction X, towards the bottom 3.

In FIG. 1, the threaded ring 8 is shown as a section view along the axis I-I shown in FIG. 2. The threaded ring 8 has a thread 81 on an internal surface. The thread 81 corresponds to the thread of the male threaded end 11 so that they can be screwed together. The threaded ring 8 is discontinuous in order to form a discontinuous area 82 in order to be deformed during insertion into or removal from the housing 7. The discontinuous area 82 has a first side edge 83 parallel to a second side edge 84 that can respectively engage with a first side edge 91 and a second side edge 92 of a rib 9 present on the internal surface of the peripheral side wall 4 in order to rotationally stop the threaded ring 8. The rib 9 is thus intended to block any rotational movement of the threaded ring 8 relative to the main body in order to allow the threaded ring 8 to be screwed onto or unscrewed from the male threaded end 11 of the tubular component 10.

According to an alternative embodiment shown in FIG. 2, the threaded ring further comprises a weakened thickness area 85 for increasing the resilient deformation capacity of the threaded ring 8, while decreasing the risk of breaking the threaded ring 8 during insertion into the housing 8.

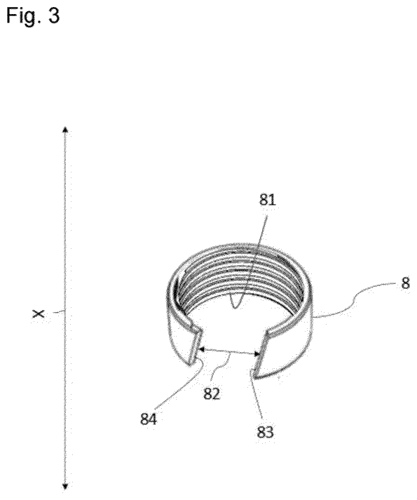

FIG. 3 shows a threaded ring 8 according to another embodiment. In this embodiment, the first side edge 83 and the second side edge 82 of the threaded ring 8 are parallel to each other and are at an angle relative to the axial direction X.

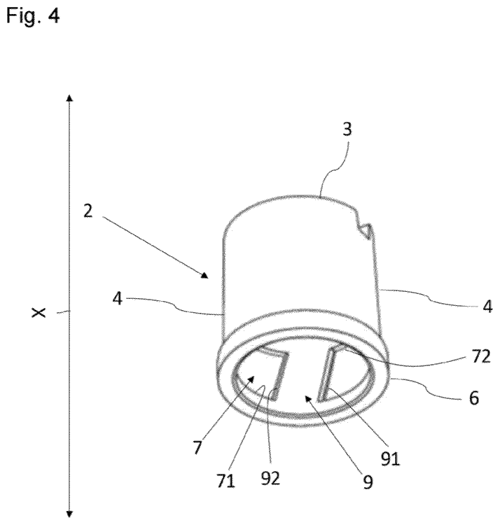

FIG. 4 shows a main body 2 adapted to receive the threaded ring 8 shown in FIG. 3. The rib 9 has, in a complementary manner to the discontinuous area 82 shown in FIG. 3, a first side edge 91 and a second side edge 92 parallel to each other and at an angle relative to the axial direction X. The first side edge 91 and the second side edge 92 respectively engage with the first side edge 83 and with the second side edge 82 in order to place the housing of the threaded ring 8 in the housing 7 and to block the rotational movement of the threaded ring 8 relative to the main body 2.

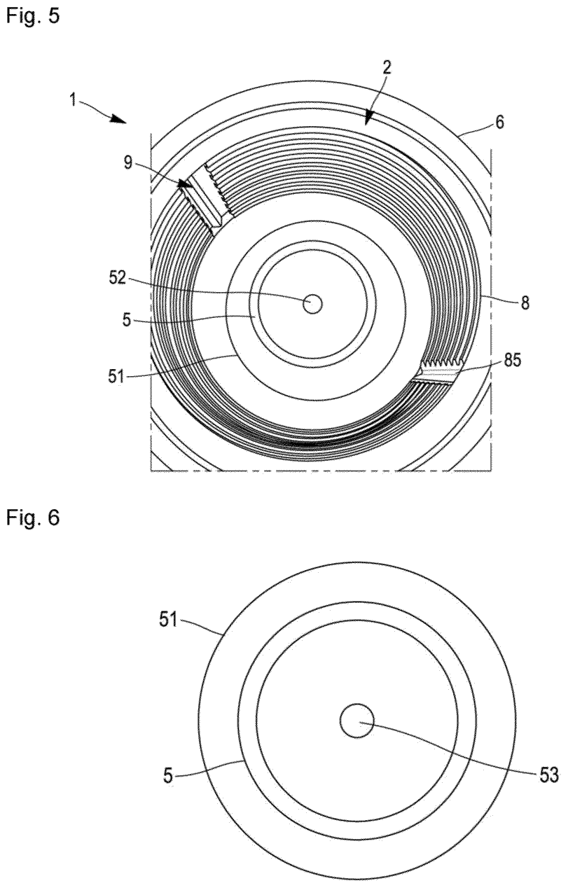

FIG. 5 shows a protector 1 comprising a main body 2 and a threaded ring 8 housed in a housing. Similar to the previous figures, the protector 1 comprises a lower seal 5 and an upper seal 6, between which the housing is located. The housing for receiving the threaded ring 8 extends around the peripheral side wall 4, over an angular sector of approximately 350°. The lower seal 5 is detachably attached to the main body via a fastener 52 and has a truncated cone shape diverging towards the bottom wall in order to allow a sealed contact with an internal surface of the male threaded end portion. The lower seal 5 removed from the protector 1 is shown in FIG. 6. The lower seal 5 shown in FIG. 6 has a hole 53 for integrating the fastener 52 in order to fasten the internal seal 5 on the bottom wall 3 of the main body 2.

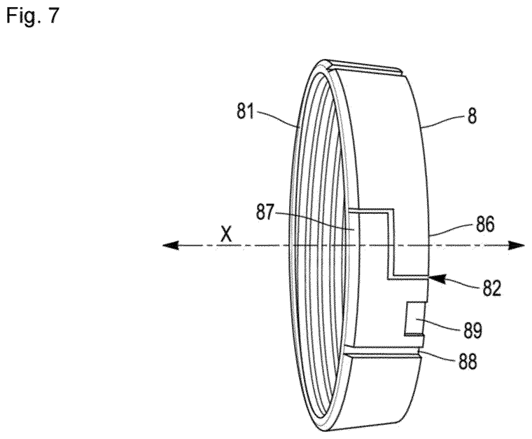

FIG. 7 shows a threaded ring 8 according to another embodiment. The threaded ring 8 assumes the general shape of a cylinder for rotating about the axial direction X. The threaded ring 8 also has a stair-shaped discontinuous area 82. This discontinuous shape 82 is particularly advantageous in that it allows a threaded ring 8 to be obtained with a thread 81 around the entire internal circumference of the threaded ring 8. A protector comprising this threaded ring 8 therefore can be screwed and firmly held onto the thread of the corresponding threaded end. Furthermore, this stair-shaped discontinuous shape thus forms a first threaded ring portion 86 and a second threaded ring portion 87 that are facing each other and will absorb any forces directed in the axial direction X. The threaded ring 8 is therefore more resistant to this type of stress.

The threaded ring 8 further comprises a groove 88 and a notch 89 located in the vicinity of the groove 88 on an external, non-threaded surface of the threaded ring 8. The groove 88 is intended to engage with a rib (not shown) located on an internal surface of the peripheral side wall in order to rotatably secure the non-threaded surface of the threaded ring 8 with the internal surface of the peripheral side wall.

The notch 89 allows the end of a tool, for example, a screwdriver, to be inserted in order to facilitate the removal of the threaded ring 8.

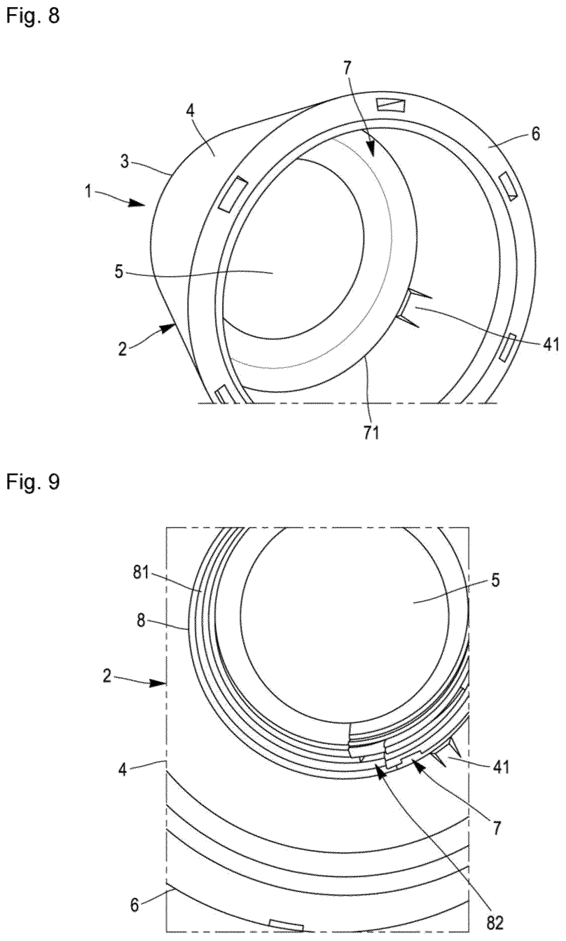

FIG. 8 shows the main body 2 of a protector 1 in which the threaded ring 8 of FIG. 7 is used. In this embodiment, the housing 7 is hollowed out of the thickness of the internal surface of the peripheral side wall 4 and completely extends around the peripheral side wall 4, i.e., over an angular sector of 360°. The upper flange 71 has a notch 41 intended to be aligned with the notch 89 in order to facilitate the removal of the threaded ring 8 from the housing 7 of the main body 2.

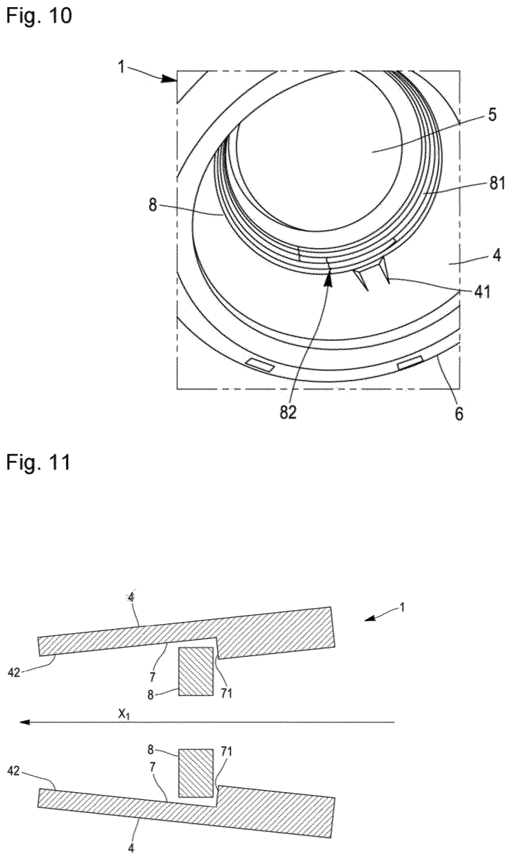

FIG. 9 shows the insertion of the threaded ring 8 shown in FIG. 7 into the housing 7 shown in FIG. 8. The threaded ring 8 is deformed by virtue of its resilient deformation properties that are particularly afforded by the discontinuous area 82. Thus, the threaded ring can be easily inserted into the housing 7 of the main body 2 in order to form the protector 1, which is shown in FIG. 10. In FIG. 10, the threaded ring is perfectly integrated into the housing 7. Furthermore, the notch 41 facilitates the removal of the ring 8, in particular to replace it.

FIG. 11 shows a protector comprising a peripheral side wall 4 of frustoconical shape that allows a rotational movement of the threaded ring 8 to be blocked when screwing the tubular component. The peripheral side wall 4 comprises a frustoconical portion that converges towards the bottom wall. The frustoconical portion shown in FIG. 11 allows the non-threaded external surface of the threaded ring 8 to be frictionally secured with the internal surface 42 of the peripheral side wall 4 when an axial thrust force is exerted by the tubular component (not shown) on the threaded ring in the direction X₁, i.e., the threaded ring 8 is moved from the upper flange 71 of the housing 7 towards the bottom wall.

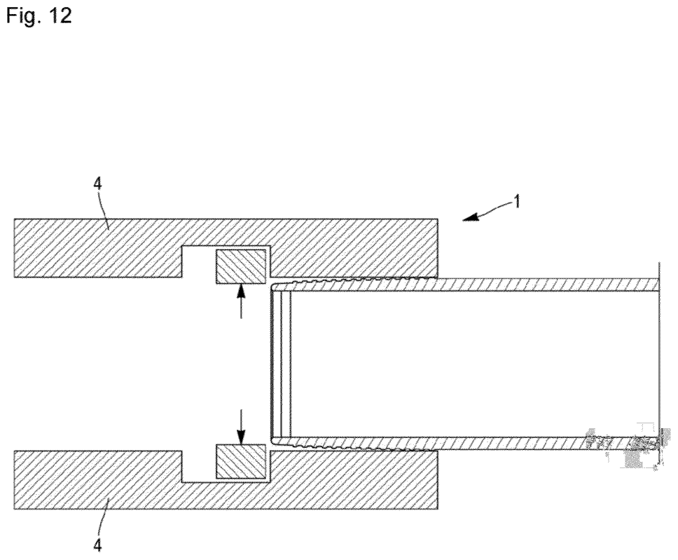

FIG. 12 shows a protector that also allows a rotational movement of the threaded ring 8 to be frictionally blocked when screwing the tubular component. The thickness of the threaded ring 8 is greater than the depth of the housing 7, so that the threaded ring 8 protrudes slightly. The diameter of the tubular component 10 is slightly greater than the initial diameter of the threaded ring 8. When the tubular component 10 enters the protector 1 by exerting an axial thrust force in the direction X₁, the threaded ring 8 will come into abutment on the lower edge 72 of the housing 7, the friction exerted by the threaded ring 8 on the lower edge 72 will initiate the screwing of the protector 1 onto the male threaded end 11 of the tubular component 10. When screwing the protector 1, a radial outward force, shown by Y₁ and Y₂, is then exerted on the threaded ring, causing radial expansion of the threaded ring 8. Thus, the non-threaded surface of the threaded ring 8 is pressed against the internal surface 42 of the peripheral side wall 4, generating frictional blocking against the peripheral side wall 4 of the threaded ring 8 during rotation. Thus, the protector 1 can be easily screwed onto the male threaded end 11.

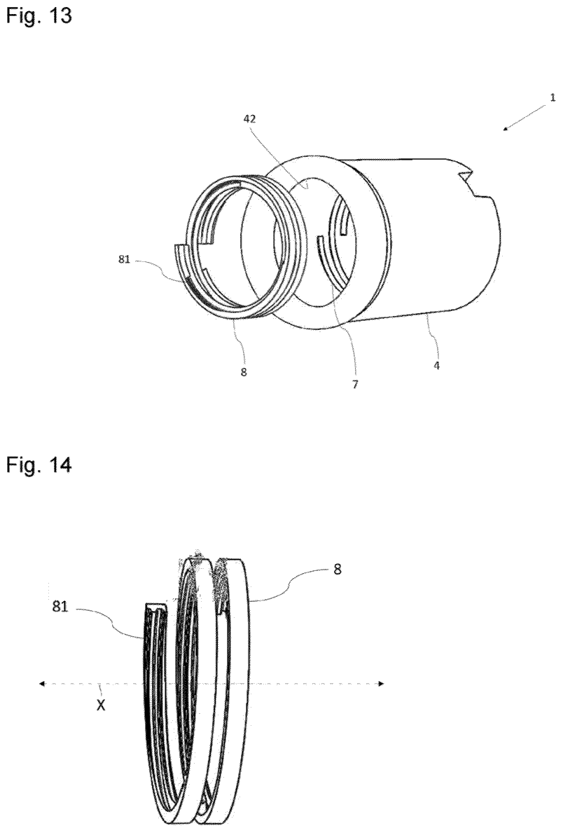

FIG. 13 shows a protector 1 according to another embodiment comprising a housing 7 and a threaded ring 8. The threaded ring 8 is shown as a perspective view in FIG. 14. The threaded ring 8 is helical shaped and comprises two turns that are spaced apart from each other about the same axis X. The threaded ring 8 is discontinuous, i.e., the two ends of the threaded ring 8 do not meet. In a complementary manner, the housing 7 is hollowed out of the thickness of the inner wall 42 of the peripheral side wall 4 and assumes a shape corresponding to the helix of the threaded ring 8. Thus, the threaded ring can be inserted and held in the housing 7 in order to allow screwing of a male threaded end of a tubular component.

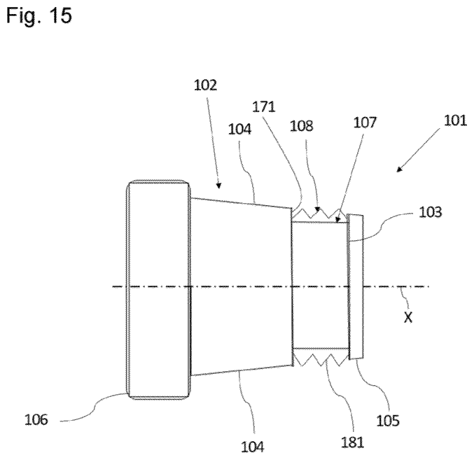

FIGS. 15 to 17 show a protector 101 for protecting a tubular component 110 having a female threaded end, i.e., having an internal thread. Elements similar or identical to those in the preceding figures have a reference numeral plus 100 compared to the preceding figures.

FIG. 15 shows a protector 101 comprising a main body 102 intended to be inserted into the female threaded end portion. The main body 102 comprises a bottom wall 103 and a peripheral side wall 104 extending from the bottom wall 103 in an axial direction X completely around the bottom wall 103. The peripheral side wall 104 has an upper end remote from the bottom wall 103.

A lower seal 105 is located on the bottom wall 103 and is intended to establish a sealed contact with an internal surface of the female threaded end.

An upper seal 106 is located on the upper end and is intended to establish a sealed contact with an external surface of the female threaded end.

An external surface of the peripheral side wall 4 of the main body 2 has a housing 107 located between the lower seal 105 and the upper seal 106.

The housing 107 is provided in a thickness of the external surface of the peripheral side wall 104 and extends around the peripheral side wall 104. The housing 107 is intended to receive a threaded ring 108. The housing 107 has an upper flange 171 intended to stop the threaded ring 108 in the axial direction X, towards the upper seal 106, and a lower flange 172 intended to stop the ring in the axial direction X, towards the bottom 103.

A threaded ring 108 is detachably housed in said housing 107, the threaded ring 108 has a thread 181 on an external surface of the peripheral side wall 104 to allow the protector 100 to be screwed onto the female threaded end, i.e., onto an internal thread.

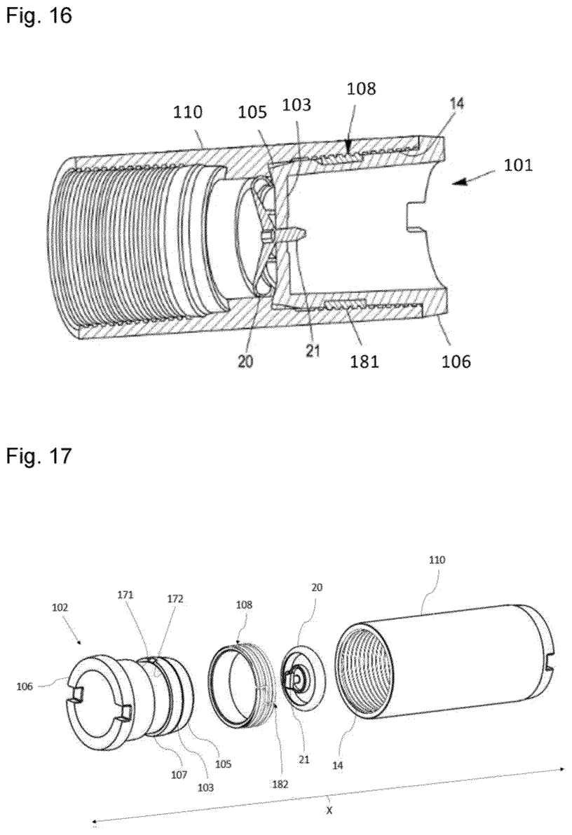

FIG. 16 shows a tubular component 110 and a corresponding protector 100 screwed onto said tubular component 110. The bottom wall 103 and the lower seal 105 have a through hole 131 that is intended to receive a stud 21 of an internal plug 20. The tubular component 110 has a female threaded end, i.e., having an internal thread 14. The lower seal 105 establishes a sealed contact with an internal surface of the female threaded end and the external seal 106 establishes a sealed contact with an external surface of the female threaded end.

FIG. 17 shows an exploded view of the protector 101 shown in FIGS. 16 and 17.

The tubular component 110 is of general cylindrical shape and has a female threaded end, i.e., having an internal thread 14.

The threaded ring 108 is discontinuous in order to form a stair-shaped interruption area 182 in a manner similar to FIG. 7, so as to be able to be deformed when inserted into the housing 107 or removed from said housing 107.

The housing 107 has an upper flange 171 intended to stop the ring in the axial direction, towards the upper seal 106, and a lower flange 172 intended to stop the threaded ring 8 in the axial direction X, towards the bottom 103.

All the alternative embodiments of threaded rings 8 previously described for the protector in order to protect a male threaded end are adaptable for the protector in order to protect the female end 14 by reversing the threaded surface with the non-threaded surface.

According to an alternative embodiment (not shown) of the protector for protecting a male or female threaded end, the housing is arranged in the entire thickness of the peripheral side wall, i.e., the housing passes through the entire thickness of the peripheral side wall and extends over a first portion of the circumference of the peripheral side wall. The threaded ring housed in the housing is held in this housing via a column of casing pipes located at least around the protector. The threaded ring further comprises a groove that engages with a rib formed by a second portion of the circumference of the peripheral side wall that does not comprise the housing. Thus, the threaded ring is radially held in the housing, i.e., the movement of the threaded ring is rotationally blocked.

Although the invention has been described in relation to several particular embodiments, it is clear that it is by no means limited thereto and that it includes all the technical equivalents of the described means, as well as the combinations thereof if these fall within the scope of the invention.

The use of the verbs “comprise” or “include” and their conjugated forms does not exclude the presence of elements or steps other than those described in a claim.

In the claims, any reference sign between brackets must not be interpreted as being a limitation of the claim.

1. A protector for protecting a male or female threaded end of a tubular component for drilling, for the exploitation of hydrocarbon wells, for transporting oil and gas, for transporting or storing hydrogen, for capturing carbon or geothermal energy, the male or female threaded end being provided with at least one external or internal thread, the protector comprising:
a main body that is intended to receive the male or female threaded end, the main body comprising a peripheral side wall extending in an axial direction, wherein a housing is provided in a thickness of the peripheral side wall, said housing extending around the peripheral side wall;
at least one threaded ring detachably housed in said housing, the threaded ring having a thread that is intended to be screwed onto the external or internal thread of the male or female threaded end.

2. The protector according to claim 1, wherein the threaded ring is discontinuous in order to be able to be deformed when inserted into the housing or removed from said housing.

3. The protector according to claim 1, wherein the threaded ring has a weakened thickness area in order to increase the resilient deformability of said threaded ring.

4. The protector according to claim 1, wherein a shape of the threaded ring and a corresponding shape of the housing are selected from among: a cylindrical shape, a stepped cylindrical shape, a helical shape and a frustoconical shape.

5. The protector according to claim 1, wherein the housing has at least one flange intended to stop the threaded ring in the axial direction.

6. The protector according to claim 5, wherein the flange has a notch intended to facilitate the removal of the threaded ring from the main body.

7. The protector according to claim 1, wherein a blocking means blocks a rotational movement of the threaded ring relative to the main body in order to be able to screw or unscrew the threaded ring by exerting a rotational torque on the main body.

8. The protector according to claim 7, wherein the blocking means comprises a rib-groove system for rotationally securing an external or internal surface of the threaded ring to an internal or external surface of the peripheral side wall.

9. The protector according to claim 8, wherein the threaded ring comprises a discontinuous area, said discontinuous area forming said groove, and wherein the discontinuous area engages with a rib formed on the internal or external surface of the peripheral side wall.

10. The protector according to claim 8, wherein the rib-groove system comprises a groove formed in a non-threaded surface of the threaded ring and a rib located in the housing and intended to be housed in said groove.

11. The protector according to claim 8, wherein the blocking means is selected from among:
a frustoconical portion formed by a non-threaded surface of the threaded ring and/or by an internal or external surface of the peripheral side wall, the frustoconical portion allowing the non-threaded surface of the threaded ring to be frictionally secured to the internal surface or to the external surface of the peripheral side wall in response to an axial thrust force exerted on the threaded ring towards the bottom wall;
a thickness of the threaded ring that is greater than a depth of the housing in order to frictionally secure the non-threaded surface of the threaded ring to the internal or external surface of the peripheral side wall by screwing the external or internal thread of the male or female threaded end of the tubular component to the threaded ring, with the male or female threaded end of the tubular component being adapted to cause radial expansion of the threaded ring in response to said screwing.

12. The protector according to claim 1, wherein the threaded ring and/or the main body is/are manufactured by additive manufacturing, by casting or by machining from one or more material(s).

13. The protector according to claim 1, wherein the main body has a bottom wall that is located at an axial end of the peripheral side wall, with the peripheral side wall completely extending around the bottom wall.

14. The protector according to claim 13, wherein a lower seal is located on the bottom wall and is intended to establish a sealed contact with the male or female threaded end of the tubular component.

15. The protector according to claim 13, wherein the peripheral side wall has an axial end remote from the bottom wall, with an upper seal being located on the axial end and being intended to establish a sealed contact with the male or female threaded end of the tubular component.

16. An assembly comprising a tubular component having a male or female threaded end and a protector according to claim 1 attached to the male or female threaded end by screwing.
